(19) United States
(12) Patent Application Publication
(10) Pub. No.: US 2022/0252714 A1
(43) Pub. Date: Aug. 11, 2022

(54) RADAR SIGNAL PROCESSING DEVICE, RADAR SENSOR SYSTEM, AND SIGNAL PROCESSING METHOD

(71) Applicant: Mitsubishi Electric Corporation, Tokyo (JP)

(72) Inventors: Takayuki KITAMURA, Tokyo (JP); Noboru OISHI, Tokyo (JP); Kei SUWA, Tokyo (JP)

(73) Assignee: Mitsubishi Electric Corporation, Tokyo (JP)

(21) Appl. No.: 17/722,826

(22) Filed: Apr. 18, 2022

Related U.S. Application Data
(63) Continuation of application No. PCT/JP2019/047676, filed on Dec. 5, 2019.

(51) Int. Cl. G01S 13/78; G01S 7/41; G01S 7/282

(52) U.S. Cl. CPC G01S 13/78; G01S 7/282; G01S 7/415

(57) ABSTRACT

A radar signal processing device includes: a frequency analysis unit performing frequency analysis on a reception signal of at least one reception channel generated by a sensor unit; a target object discriminating unit calculating, on the basis of the frequency analysis, a measurement value of at least one type of feature amounts that characterizes a state of a target object moving in an observation space; and a learned data storing unit storing at least one learned data set that defines a probability distribution in which the at least one types of feature amounts is measured when a recognition targets is observed in the observation space. The target object discriminating unit calculates a posterior probability that a target object belongs to each of class(es) from the measurement value using a learned data set and discriminates the target object on the basis of the calculated posterior probability.

### CROSS REFERENCE TO RELATED APPLICATIONS

This application is a Continuation of PCT International Application No. PCT/JP2019/047676, filed on Dec. 5, 2019, which is hereby expressly incorporated by reference into the present application.

### TECHNICAL FIELD

The present invention relates to radar sensor technology capable of estimating the type of a target object using a radio wave in a high frequency band such as a millimeter wave band.

### BACKGROUND ART

Conventionally, as sensor systems that detect a target object such as a living body in a contactless manner, optical sensor systems using an optical sensor such as an optical camera or an infrared sensor are widely adopted. For example, there is known technology of estimating the type (for example, adults or infants) of a target object appearing in a captured image with high accuracy by analyzing the captured image obtained by an optical camera by signal processing. However, light such as visible light or infrared light cannot pass through substances such as clothing, walls, and plastics. For this reason, it is difficult to optically detect the target object in a situation where a substance that shields light is interposed in a space between an optical sensor system and a target object. For example, for a sleeping infant covered with a blanket that shields light, it is difficult for the light sensor system to accurately estimate the state of the infant.

In order to address such a situation, radar sensor systems using radio waves in a high frequency band that pass through non-metallic substances have been proposed. For example, Patent Literature 1 (JP 2017-181225 A) discloses a vehicle occupant detection device that detects an occupant in a passenger compartment of a car using frequency-modulated continuous wave (FMCW) radar. The vehicle occupant detection device includes an FMCW radar disposed in a passenger compartment and a reception signal processing unit that calculates a frequency spectrum by frequency analysis of a beat signal generated by the FMCW radar. The reception signal processing unit detects the number, position(s), and biological information (information indicating respiration and heartbeat) of occupants in the passenger compartment on the basis of the frequency spectrum. Here, the biological information is detected on the basis of the fluctuation characteristics of the frequency spectrum.

### CITATION LIST

### Patent Literature

Patent Literature 1: JP 2017-181225 A (see, for example, FIG. 1 and paragraphs [0031] to [0035])

### SUMMARY OF INVENTION

### Technical Problem

As described above, the vehicle occupant detection device disclosed in Patent Literature 1 can detect biological information of a target object on the basis of the fluctuation characteristics of the frequency spectrum. However, it is difficult to discriminate the target object with high accuracy only from the fluctuation characteristics of the frequency spectrum.

In view of the above, an object of the present invention is to provide a radar signal processing device, a radar sensor system, and a signal processing method capable of discriminating a target object with high accuracy using a radar technology adopting a radio wave in a frequency band lower than the optical frequency domain.

### Solution to Problem

A radar signal processing device according to the present invention operates in cooperation with a sensor unit comprising a single or a plurality of reception antennas to receive a reflection wave generated by reflection of a transmission radio wave in a frequency band lower than a frequency in an optical frequency domain in an observation space and a reception circuit to generate a reception signal of each of a single or a plurality of reception channels by performing signal processing on an output signal of each of the single or the plurality of reception antennas, the radar signal processing device comprising processing circuitry to perform frequency analysis on the reception signal, to perform calculation of a measurement value of each of a single or a plurality of types of feature amounts, each of the single or the plurality of feature amounts characterizing a state of each of a single or a plurality of target objects moving in the observation space on a basis of a result of the frequency analysis, to store a single or a plurality of learned data sets that define a probability distribution in which the single or the plurality of types of feature amounts are each measured when an object belonging to a single or a plurality of classes is observed in the observation space, to perform calculation of a posterior probability that each of the single or the plurality of target objects belongs to each of the single or the plurality of classes from the measurement value by Bayes' theorem using the learned data set and to discriminate each of the single or the plurality of target objects on a basis of the posterior probability that has been calculated, to perform conversion of the reception signal into a frequency domain signal in a frequency domain corresponding to spatial coordinates of the observation space, and to detect each of the single or the plurality of target objects from the frequency domain signal.

### Advantageous Effects of Invention

According to one aspect of the present invention, a posterior probability that each of the single or the plurality of target objects belongs to each of the single or the plurality of classes is calculated from the measurement value by Bayes' theorem using the learned data set and each of the single or the plurality of target objects is discriminated on the basis of the posterior probability that has been calculated. Thus, the target object can be discriminated with high accuracy.

### BRIEF DESCRIPTION OF DRAWINGS

FIG. 1 is a block diagram schematically illustrating a configuration of a radar sensor system according to a first embodiment of the present invention.

FIGS. 2A and 2B are graphs illustrating a concept of a transmission frequency according to the FMCW scheme.

FIG. 3 is a graph conceptually illustrating a relationship between the transmission frequency and a reception frequency.

FIG. 4 is a diagram illustrating an example of an antenna array in which reception antennas are linearly arrayed.

FIG. 5 is a block diagram illustrating a schematic configuration of a hardware configuration example of a radar signal processing device according to the first embodiment.

FIG. 6 is a block diagram illustrating a schematic configuration of a frequency analysis unit according to the first embodiment.

FIG. 7 is a block diagram schematically illustrating a configuration example of a signal component extracting unit according to the first embodiment.

FIGS. 8A and 8B are block diagrams schematically illustrating a configuration example of a Doppler spectrum calculating unit of the first embodiment.

FIG. 9 is a block diagram illustrating a schematic configuration of a target object discriminating unit and a learned data storing unit according to the first embodiment.

FIG. 10 is a flowchart schematically illustrating a procedure of signal processing according to the first embodiment.

FIG. 11 is a flowchart schematically illustrating a procedure of frequency analysis processing according to the first embodiment.

FIGS. 12A and 12B are graphs conceptually illustrating an average Doppler spectrum.

FIGS. 13A and 13B are diagrams illustrating a radar sensor system installed in a compartment of a vehicle.

FIG. 14 is a graph illustrating a two-dimensional spectrum.

FIG. 15 is a graph illustrating an average Doppler spectrum.

FIG. 16 is a graph illustrating an average Doppler spectrum.

FIG. 17 is a graph illustrating an average Doppler spectrum.

FIGS. 18A, 18B, and 18C are graphs each illustrating an average Doppler spectrum calculated when an infant in the awake state is observed.

FIGS. 19A, 19B, and 19C are graphs each illustrating an average Doppler spectrum calculated when the motion of a doll imitating a sleeping infant is observed.

FIG. 20 is a graph illustrating histogram distributions of a first feature amount.

FIG. 21 is a graph illustrating histogram distributions of the first feature amount.

FIG. 22 is a graph illustrating histogram distributions of a second feature amount.

FIG. 23 is a graph illustrating histogram distributions of the second feature amount.

FIG. 24 is a graph illustrating histogram distributions of a third feature amount.

FIG. 25 is a graph illustrating histogram distributions of a fourth feature amount.

FIG. 26 is a graph illustrating histogram distributions of the fourth feature amount.

FIG. 27 is a graph illustrating the time transition of the posterior probability calculated in a case where only a sleeping infant is observed in a vehicle compartment.

FIG. 28 is a graph illustrating the time transition of the posterior probability calculated in a case where only vibration of a vehicle body is observed in a vehicle compartment.

FIG. 29 is a graph illustrating the time transition of the posterior probability calculated in a case where only a vibrating smartphone is observed in a vehicle compartment.

### DESCRIPTION OF EMBODIMENTS

Hereinafter, an embodiment of the present invention will be described in detail with reference to the drawings. Note that components denoted by the same symbol throughout the drawings have the same configuration and the same function.

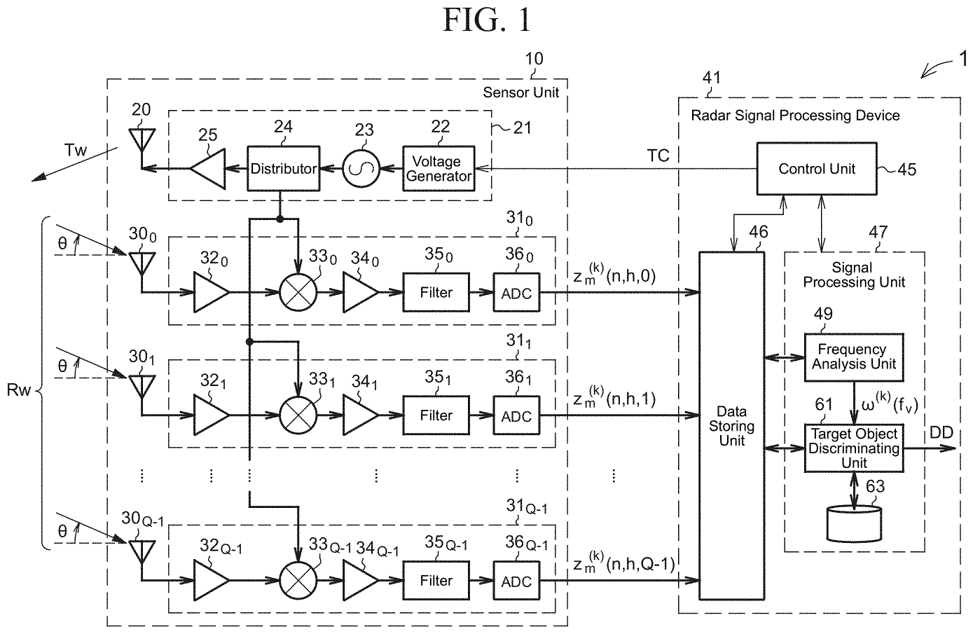

FIG. 1 is a block diagram schematically illustrating a configuration of a radar sensor system 1 according to a first embodiment of the present invention. As illustrated in FIG. 1, the radar sensor system 1 includes a sensor unit 10 and a radar signal processing device 41 that operates in cooperation with the sensor unit 10. The sensor unit 10 includes a transmission circuit 21 that generates a series of frequency-modulated waves (a series of transmission pulses) in a frequency band such as a millimeter wave band in a high frequency band (about 3 to 30 GHz) lower than the optical frequency domain, a transmission antenna 20 that transmits the series of frequency-modulated waves toward an observation space as a transmission wave Tw, an antenna array including reception antennas 30₀ to 30_{Q-1} spatially arranged so as to receive a reflection wave Rw generated by reflection of the transmission wave Tw in the observation space, and receivers 31₀ to 31_{Q-1} that performs signal processing on each output signal of the reception antennas 30₀ to 30_{Q-1}, thereby outputting digital reception signals of Q reception channels in parallel. The radar signal processing device 41 performs digital signal processing on each of the digital reception signals. A reception circuit of the present embodiment includes Q receivers 31₀ to 31_{Q-1}.

Q represents an integer greater than or equal to 3 indicating the number of reception antennas 30₀ to 30_{Q-1} (the number of reception channels). Note that Q is not limited to an integer greater than or equal to 3, and may be 1 or 2.

The transmission circuit 21 includes a voltage generator 22, a voltage-controlled oscillator 23, a distributor 24, and an amplifier 25. The voltage generator 22 generates a modulation voltage in accordance with a control signal TC supplied from the radar signal processing device 41 and supplies the modulation voltage to the voltage-controlled oscillator 23. The voltage-controlled oscillator 23 repeatedly outputs a frequency-modulated wave signal having a modulation frequency that rises or falls with time depending on the modulation voltage in accordance with a predetermined frequency modulation scheme. The distributor 24 divides the frequency-modulated wave signal input from the voltage-controlled oscillator 23 into a transmission wave signal and a local signal. The distributor 24 supplies the transmission wave signal to the amplifier 25 and simultaneously supplies the local signal to the receivers 31₀ to 31_{Q-1}. The transmission wave signal is amplified by the amplifier 25. The transmission antenna 20 transmits a transmission wave Tw based on an output signal of the amplifier 25 toward an observation space.

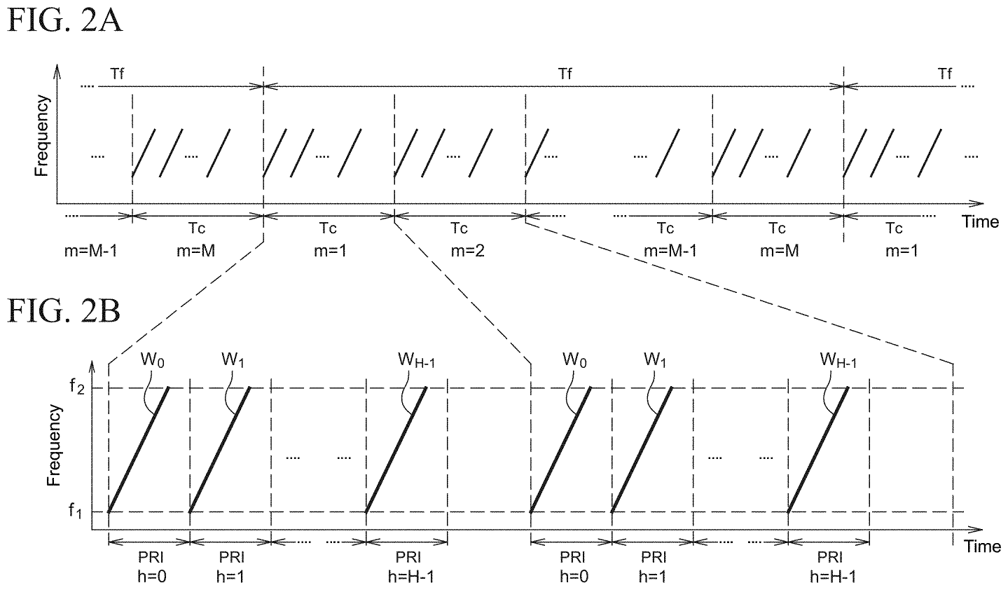

As a predetermined frequency modulation scheme, the frequency-modulated continuous wave (FMCW) scheme can be used. The frequency of the frequency-modulated wave signal, that is, a transmission frequency is only required to be swept so as to continuously rise or fall with time within a certain frequency band. FIGS. 2A and 2B are graphs illustrating a concept of a transmission frequency according to the fast chirp modulation (FCM) scheme which is a type of the FMCW scheme. In the graphs of FIGS. 2A and 2B, the horizontal axis represents time, and the vertical axis represents the transmission frequency.

As illustrated in FIG. 2A, each frame period Tf (for example, of a few seconds) is divided into M cycle periods Tc. M represents an integer greater than or equal to 4, but it is not limited thereto, and M may be 2 or 3. Variable m assigned to each cycle period Tc in FIG. 2A represents an integer within a range of 1 to M and indicates a number (hereinafter referred to as “cycle number”) assigned to a cycle period Tc. In FIG. 2B, the transmission frequencies in the first and second cycle periods Tc and Tc are displayed. As illustrated in FIG. 2B, in each cycle period Tc, the transmission circuit 21 sequentially generates H frequency-modulated waves (a series of transmission pulses) having transmission frequencies W₀ to W_{H-1}, respectively, in a specific pulse repetition interval (PRI). In each frequency-modulated wave, the transmission frequency is modulated in such a manner that the transmission frequency continuously rises with time in a frequency band from a lower limit frequency f₁ to an upper limit frequency f₂. Variable h assigned to each pulse repetition period (PRI) in FIG. 2B represents an integer in a range of 0 to H−1 and indicates the number (hereinafter referred to as “pulse number”.) assigned to a frequency-modulated wave (transmission pulse).

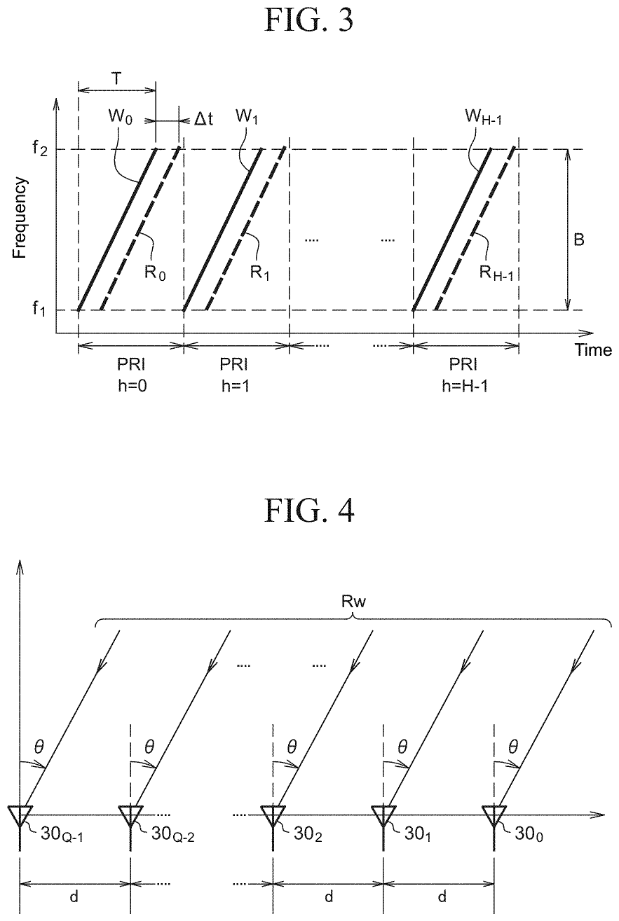

FIG. 3 is a graph conceptually illustrating a relationship between the transmission frequencies W₀ to W_{H-1} of the transmission wave Tw and frequencies (reception frequencies) R₀ to R_{H-1} of a reception wave Rw. As illustrated in FIG. 3, each of the transmission frequencies W₀ to W_{H-1} is modulated within a frequency band B at a modulation time width T. In the example of FIG. 3, the reception wave Rw is received with a delay by a delay time ΔT with respect to the transmission wave Tw. The delay time ΔT corresponds to a round-trip propagation time of the radio wave between the sensor unit 10 and a target object. It is possible to obtain a distance to the target object on the basis of the difference (beat frequency) between a transmission frequency Wₕ and a reception frequency Rₕ corresponding thereto.

The reception antennas 30₀ to 30_{Q-1} may only required to be arrayed in a linear, planar, or a curved surface shape. FIG. 4 is a diagram illustrating an example of an antenna array in which the reception antennas 30₀ to 30_{Q-1} are linearly arrayed. In the example of FIG. 4, the reception antennas 30₀ to 30_{Q-1} are linearly arrayed at equal intervals d (for example, half-wavelength intervals). An azimuth angle θ can be obtained on the basis of phase differences generated between the signals received by the reception antenna 30₀ to 30_{Q-1}.

Referring to FIG. 1, a q-th receiver 31_{q} includes a low noise amplifier (LNA) 32_{q}, a mixer 33_{q}, an IF amplifier 34_{q}, a filter 35_{q}, and an A/D converter (ADC) 36_{q}, where q is any integer within a range of 0 to Q−1.

The low noise amplifier 32_{q} amplifies an output signal of a reception antenna 30_{q} and outputs the amplified signal to a mixer 33_{q}. The mixer 33_{q} generates a beat signal in an intermediate frequency band by mixing the amplified signal and the local signal supplied from the distributor 24. The IF amplifier 34_{q} amplifies the beat signal input from the mixer 33_{q} and outputs the amplified beat signal to the filter 35_{q}. The filter 35_{q} generates an analog reception signal by suppressing unwanted frequency components in the amplified beat signal and outputs the analog reception signal. The ADC 36_{q} converts the analog reception signal into a digital reception signal zₘ^{(k)}(n, h, q) at a predetermined sample rate and outputs the digital reception signal zₘ^{(k)} (n, h, q) to the radar signal processing device 41. The superscript k is a number (hereinafter referred to as “frame number”) assigned to a frame period Tf, and n represents an integer indicating a sample number. The digital reception signal zₘ^{(k)}(n, h, q) is a complex signal having an in-phase component and a quadrature-phase component. Hereinafter, the digital reception signal will be referred to as a “reception signal”.

Note that, in the present embodiment, the sensor unit 10 includes ADCs 36₀ to 36_{Q-1}; however, it is not limited thereto. In a mode in which the sensor unit 10 does not include the ADCs 36₀ to 36_{Q-1}, it is only required that the radar signal processing device 41 include the ADCs 36₀ to 36_{Q-1}.

As illustrated in FIG. 1, the receivers 31₀ to 31_{Q-1} output reception signals zₘ^{(k)}(n, h, 0), zₘ^{(k)}(n, h, 1), . . . , zₘ^{(k)}(n, h, Q−1) to the radar signal processing device 41 in parallel.

The radar signal processing device 41 includes a data storing unit 46 that temporarily stores the reception signals zₘ^{(k)}(n, h, 0), zₘ^{(k)}(n, h, 1), . . . , zₘ^{(k)}(n, h, Q−1) input in parallel from the receivers 31₀ to 31_{Q-1}, a signal processing unit 47 that can discriminate a target object in an observation space by applying digital signal processing to the reception signals zₘ^{(k)}(n, h, 0) to zₘ^{(k)}(n, h, Q−1) read from the data storing unit 46, and a control unit 45 that controls operations of the transmission circuit 21, the data storing unit 46, and the signal processing unit 47. As the data storing unit 46, it is only required that a random access memory (RAM) having high-speed response performance be used. The control unit 45 supplies a control signal TC for generating a modulation voltage to the transmission circuit 21. Further, the control unit 45 can perform read control and write control of a signal with respect to the data storing unit 46.

The signal processing unit 47 includes a frequency analysis unit 49, a target object discriminating unit 61, and a leamed data storing unit 63. The frequency analysis unit 49 performs frequency analysis on the reception signals zₘ^{(k)}(n, h, 0) to zₘ^{(k)}(n, h, Q−1) read from the data storing unit 46 and supplies a result of the frequency analysis to the target object discriminating unit 61. The target object discriminating unit 61 can calculate measurement values of a single or a plurality of types of feature amounts that characterize the state of the target object moving in the observation space on the basis of the result of the frequency analysis. The learned data storing unit 63 stores a single or a plurality of types of learned data sets having been obtained in advance by machine learning. The target object discriminating unit 61 can discriminate the target object using the learned data set.

All or some of the functions of the radar signal processing device 41 can be implemented by a single or a plurality of processors including a semiconductor integrated circuit such as a digital signal processor (DSP), an application specific integrated circuit (ASIC), or a programmable logic device (PLD). The PLD is a semiconductor integrated circuit whose function can be freely modified by a designer after manufacturing of the PLD. A field-programmable gate array (FPGA) is an example of the PLD. Alternatively, all or some of the functions of the radar signal processing device 41 may be implemented by a single or a plurality of processors including an arithmetic device such as a central processing unit (CPU) or a graphics processing unit (GPU) that executes program codes of software or firmware. Further alternatively, all or some of the functions of the radar signal processing device 41 can be implemented by a single or a plurality of processors including a combination of a semiconductor integrated circuit such as a DSP, an ASIC, or a PLD and an arithmetic device such as a CPU or a GPU.

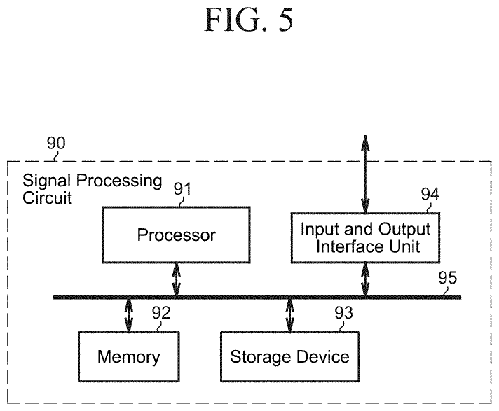

FIG. 5 is a block diagram illustrating a schematic configuration of a signal processing circuit 90, which is an example of the hardware configuration of the radar signal processing device 41 according to the first embodiment. The signal processing circuit 90 illustrated in FIG. 5 includes a processor 91, an input and output interface unit 94, a memory 92, a storage device 93, and a signal path 95. The signal path 95 is a bus for connecting the processor 91, the input and output interface unit 94, the memory 92, and the storage device 93 to each other. The input and output interface unit 94 has a function of transferring a digital signal input from the outside to the processor 91 and also has a function of outputting the digital signal transferred from the processor 91 to the outside.

The memory 92 includes a work memory used when the processor 91 executes digital signal processing and a temporary storage memory in which data used in the digital signal processing is loaded. For example, the memory 92 may be implemented by using a semiconductor memory such as a flash memory and a synchronous dynamic random access memory (SDRAM). In a case where the processor 91 includes an arithmetic device such as a CPU or a GPU, the storage device 93 can be used as a storage medium for storing codes of a signal processing program as software or firmware to be executed by the arithmetic device. For example, the storage device 93 may be implemented by using a non-volatile semiconductor memory such as a flash memory or a read only memory (ROM).

Note that although the number of processors 91 is one in the example of FIG. 5, it is not limited thereto. The hardware configuration of the radar signal processing device 41 may be implemented by using a plurality of processors that operate in cooperation with each other.

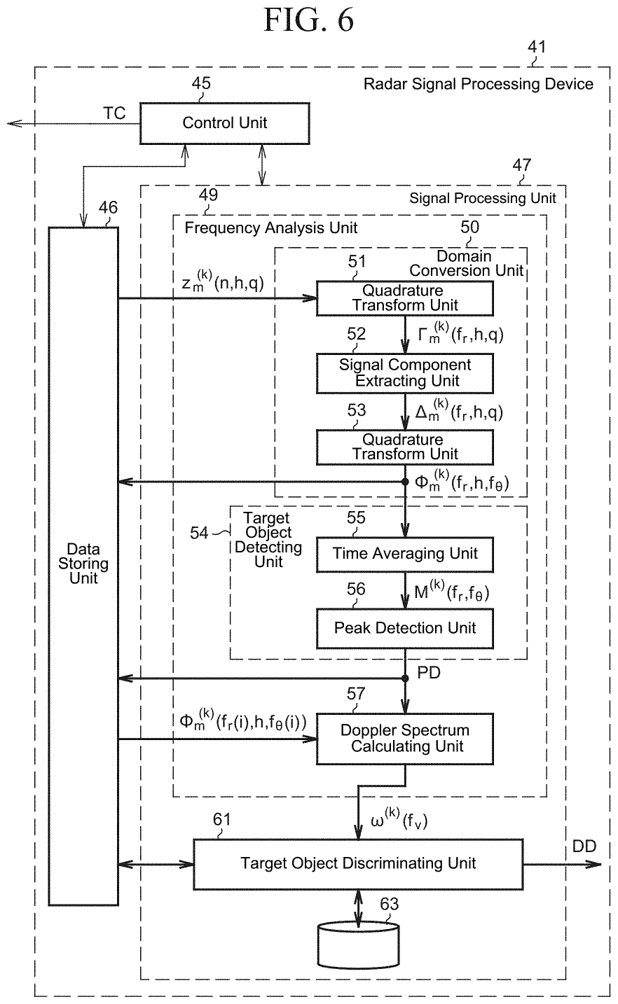

Next, the configuration and operation of the frequency analysis unit 49 in the signal processing unit 47 of the first embodiment will be described with reference to FIG. 6. FIG. 6 is a block diagram illustrating a schematic configuration of the frequency analysis unit 49 in the signal processing unit 47.

As illustrated in FIG. 6, the frequency analysis unit 49 includes a domain conversion unit 50 that converts a reception signal zₘ^{(k)}(n, h, q) in the time domain into a frequency domain signal Φₘ^{(k)}(fᵣ, h, f_{θ}) in the frequency domain corresponding to spatial coordinates (relative distance and azimuth angle) in the observation space, a target object detecting unit 54 that detects a target object moving in the observation space from the frequency domain signal Φₘ^{(k)}(fᵣ, h, f_{θ}), and a Doppler spectrum calculating unit 57. The symbol fᵣ represents a frequency number assigned to a discrete frequency value corresponding to the relative distance to the target object, and f_{θ} is a frequency number assigned to a discrete frequency value corresponding to the azimuth angle θ.

The domain conversion unit 50 includes a quadrature transform unit (first quadrature transform unit) 51, a signal component extracting unit 52, and a quadrature transform unit (second quadrature transform unit) 53.

The quadrature transform unit 51 performs discrete quadrature transform in the time direction on the reception signals zₘ^{(k)}(n, h, 0) to zₘ^{(k)}(n, h, Q−1) of the Q reception channels, thereby generating Q frequency domain signals (first frequency domain signals) Γₘ^{(k)}(fᵣ, h, 0) to Γₘ^{(k)}(fᵣ, h, Q−1) corresponding to the Q reception channels, respectively. Specifically, the quadrature transform unit 51 can calculate a frequency domain signal Γₘ^{(k)}(fᵣ, h, q) by applying a discrete Fourier transform to a frequency domain signal zₘ^{(k)}(n, h, q) for a sample number n as expressed by the following Equation (1).

$${Γ}_{m}^{( k )} ( {f}_{r} , h , q ) = {F}_{n} [ {z}_{m}^{( k )} ( n , h , q ) ] \qquad ( 1 )$$

In Equation (1), Fₙ[ ] is a discrete Fourier transform operator for the sample number n.

Next, the signal component extracting unit 52 extracts dynamic signal components Δₘ^{(k)}(fᵣ, h, 0) to Δₘ^{(k)}(fᵣ, h, Q−1) from the frequency domain signals Γₘ^{(k)}(fᵣ, h, 0) to Γₘ^{(k)}(fᵣ, h, Q−1), respectively, by removing each signal component corresponding to a stationary object from the frequency domain signals Γₘ^{(k)}(fᵣ, h, 0) to Γₘ^{(k)}(fᵣ, h, Q−1).

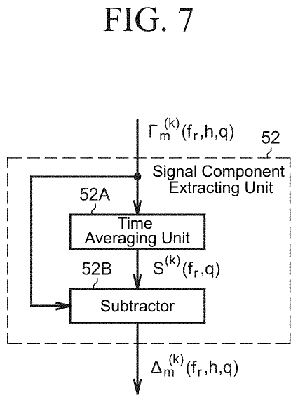

FIG. 7 is a block diagram schematically illustrating a configuration example of the signal component extracting unit 52. The signal component extracting unit 52 illustrated in FIG. 7 includes a time averaging unit 52A and a subtractor 52B. The time averaging unit 52A calculates a time-averaged signal S^{(k)}(fᵣ, q) by time-averaging frequency domain signals Γₘ^{(k)}(fᵣ, h, q) over one frame period. Since a signal component corresponding to a stationary object does not change during one frame period, the time-averaged signal S^{(k)}(fᵣ, q) can be regarded as a signal component that corresponds to the stationary object. Specifically, the time averaging unit 52A can calculate the time-averaged signal S^{(k)}(fᵣ, q) by averaging frequency domain signals Γₘ^{(k)}(fᵣ, h q) for the cycle number m and the pulse number h as expressed in the following Equation (2).

$${S}^{( k )} ( {f}_{r} , q ) = {\sum }_{m = 1}^{M} {\sum }_{h = 0}^{H - 1} {Γ}_{m}^{( k )} ( {f}_{r} , h , q ) \text{/} ( M \cdot H ) \qquad ( 2 )$$

The subtractor 52B can calculate a dynamic signal component Δₘ^{(k)}(fᵣ, h, q) corresponding to a mobile object (target object moving in the observation space) by subtracting the time-averaged signal S^{(k)}(fᵣ, q) as the background from the frequency domain signal Γₘ^{(k)}(fᵣ, h, q) as expressed in the following Equation (3).

$${Δ}_{m}^{( k )} ( {f}_{r} , h , q ) = {Γ}_{m}^{( k )} ( {f}_{r} , h , q ) - {S}^{( k )} ( {f}_{r} , q ) \qquad ( 3 )$$

Next, the quadrature transform unit 53 calculates a frequency domain signal (second frequency domain signal) Φₘ^{(k)}(fᵣ, h, f_{θ}) by performing discrete quadrature transform in the array direction of the reception antennas 30₀ to 30_{Q-1} on dynamic signal components Δₘ^{(k)}(fᵣ, h, 0) to Δₘ^{(k)}(fᵣ, h, Q−1). Specifically, the quadrature transform unit 53 can calculate a frequency domain signal Φₘ^{(k)}(fᵣ, h, f_{θ}) by applying a discrete Fourier transform to a dynamic signal component Δₘ^{(k)}(fᵣ, h, q) for a reception antenna number q as expressed by the following Equation (4).

$${Φ}_{m}^{( k )} ( {f}_{r} , h , {f}_{θ} ) = {F}_{q} [ {Δ}_{m}^{( k )} ( {f}_{r} , h , q ) ] \qquad ( 4 )$$

In Equation (4), F_{q}[ ] is a discrete Fourier transform operator for a reception antenna number q. The frequency domain signal Φₘ^{(k)}(fᵣ, h, f_{θ}) is supplied to the target object detecting unit 54 and temporarily stored in the data storing unit 46.

The target object detecting unit 54 detects information corresponding to the position coordinate values (relative distance and azimuth angle) of the target object moving in the observation space from the frequency domain signal Φₘ^{(k)}(fᵣ, h, f_{θ}). Specifically, as illustrated in FIG. 6, the target object detecting unit 54 includes a time averaging unit 55 and a peak detection unit 56. The time averaging unit 55 calculates a time-averaged signal by time-averaging frequency domain signals Φₘ^{(k)}(fᵣ, h, f_{θ}) over one frame period and calculates the absolute value of the time-averaged signal or the square of the absolute value of the time-averaged signal as a two-dimensional spectrum M^{(k)}(fᵣ, f_{θ}). More specifically, the time averaging unit 55 can calculate a time-averaged signal having a good signal-to-noise ratio by averaging frequency domain signals Φₘ^{(k)}(fᵣ, h, f_{θ}) for the cycle number m and the pulse number h as expressed in the following Equation (5) and can calculate the square of the absolute value of the time-averaged signal as the two-dimensional spectrum M^{(k)(f}ᵣ, f_{θ}).

$${M}^{( k )} ( {f}_{r} , {f}_{θ} ) = {\vert {\sum }_{h = 0}^{H - 1} {\sum }_{m = 1}^{M} {Φ}_{m}^{( k )} ( {f}_{r} , h , {f}_{θ} ) \text{/} ( H \cdot M ) \vert}^{2} \qquad ( 5 )$$

The peak detection unit 56 detects a maximum peak appearing in the two-dimensional spectrum M^{(k)}(fᵣ, f_{θ}) using a predetermined peak detection method. Examples of the predetermined peak detection method include a method of extracting a local distribution exceeding a preset threshold as a maximum peak from the two-dimensional spectrum M^{(k)}(fᵣ, f_{θ}) and a cell averaging-constant false alarm rate (CA-CFAR) that enables peak detection in which the false alarm rate is maintained at a constant rate; however, it is not limited thereto. The peak detection unit 56 supplies peak information PD, which indicates the position of a single or a plurality of maximum peaks, to the Doppler spectrum calculating unit 57 and stores the peak information PD in the data storing unit 46.

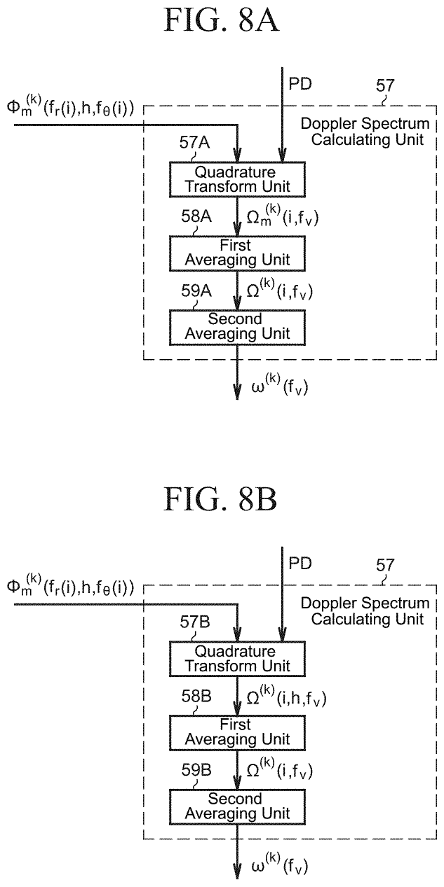

The peak information PD includes a set of frequency numbers corresponding to position coordinate values of the detected target object. Let us represent a set of frequency numbers corresponding to position coordinate values of a detected i-th target object as (fᵣ(i), f_{θ}(i)). The symbol i represents an integer representing a number assigned to the detected target object. The Doppler spectrum calculating unit 57 reads a frequency domain signal Φₘ^{(k)}(fᵣ(i), h, f_{θ}(i)) for the i-th target object from the data storing unit 46 and calculates an average Doppler spectrum ω^{(k)}(fᵥ) from the frequency domain signal Φₘ^{(k)}(fᵣ(i), h, f_{θ}(i)). The average Doppler spectrum ω^{(k)}(fᵥ) is supplied to the target object discriminating unit 61. FIG. 8A is a block diagram schematically illustrating a configuration example of the Doppler spectrum calculating unit 57, and FIG. 8B is a block diagram schematically illustrating another configuration example of the Doppler spectrum calculating unit 57.

The Doppler spectrum calculating unit 57 illustrated in FIG. 8A includes a quadrature transform unit 57A, a first averaging unit 58A, and a second averaging unit 59A. The quadrature transform unit 57A calculates a frequency domain signal (third frequency domain signal) Ωₘ^{(k)}(i, fᵥ) by performing a discrete quadrature transform on the frequency domain signal Φₘ^{(k)}(fᵣ(i), h, f_{θ}(i)) for a pulse number h. The symbol fᵥ represents a frequency number assigned to a discrete frequency value corresponding to the relative velocity of the i-th target object. Specifically, the quadrature transform unit 57A can calculate the frequency domain signal Ωₘ^{(k)}(i, fᵥ) by applying a discrete Fourier transform to the frequency domain signal Φₘ^{(k)}(fᵣ(i), h, f_{θ}(i)) for the pulse number h as expressed in the following Equation (6).

$${Ω}_{m}^{( k )} ( i , {f}_{v} ) = {F}_{h} [ {Φ}_{m}^{( k )} ( {f}_{r} ( i ) , h , {f}_{θ} ( i ) ) ] \qquad ( 6 )$$

The symbol Fₕ[ ] represents a discrete Fourier transform operator for the pulse number h.

The first averaging unit 58A calculates an averaged signal by averaging frequency domain signals Ωₘ^{(k)}(i, fᵥ) for the cycle number m and calculates the absolute value of the averaged signal or the square of the absolute value of the averaged signal as a Doppler spectrum Ω^{(k)}(i, fᵥ) related to the i-th target object. The Doppler spectrum Ω^{(k)}(i, fᵥ) may be normalized by its maximum value. Specifically, the first averaging unit 58A can calculate the Doppler spectrum Ω^{(k)}(i, fᵥ) from the frequency domain signal Ωₘ^{(k)}(i, fᵥ) as expressed by the following Equation (7).

$${Ω}^{( k )} ( i , {f}_{v} ) = {\vert {\sum }_{m = 1}^{M} {Ω}_{m}^{( k )} ( i , {f}_{v} ) \text{/} M \vert}^{2} \times {γ}_{1} \qquad ( 7 )$$

The symbol γ₁ represents a normalization factor.

The second averaging unit 59A calculates an average Doppler spectrum Ω^{(k)}(fᵥ) by further averaging the Doppler spectrum Ω^{(k)}(i, fᵥ) for the number i. The average Doppler spectrum Ω^{(k)}(fᵥ) may be normalized by its maximum value. Specifically, the second averaging unit 59A can calculate the average Doppler spectrum ω^{(k)}(fᵥ) from the Doppler spectrum Ω^{(k)}(i, fᵥ) as expressed by the following Equation (8).

$${ω}^{( k )} ( {f}_{v} ) = ( {\sum }_{i = 1}^{Np ( k )} {Ω}^{( k )} ( i , {f}_{v} ) \text{/} Np ( k ) ) \times {γ}_{2} \qquad ( 8 )$$

The symbol Np(k) represents the total number of target objects detected by the target object detecting unit 54 in a k-th frame period, and γ₂ represents a normalization factor.

On the other hand, the Doppler spectrum calculating unit 57 illustrated in FIG. 8B includes a quadrature transform unit 57B, a first averaging unit 58B, and a second averaging unit 59B. The quadrature transform unit 57B calculates a frequency domain signal (third frequency domain signal) Ω^{(k)}(i, h, fᵥ) by performing a discrete quadrature transform on the frequency domain signal Φₘ^{(k)}(fᵣ(i), h, f_{θ}(i)) for a cycle number m. The symbol fᵥ represents a frequency number assigned to a discrete frequency value corresponding to the relative velocity of the i-th target object. Specifically, the quadrature transform unit 57B can calculate the frequency domain signal Ω^{(k)}(i, h, fᵥ) by applying a discrete Fourier transform to the frequency domain signal Φₘ^{(k)}(fᵣ(i), h, f_{θ}(i)) for the cycle number m as expressed in the following Equation (9).

$${Ω}^{( k )} ( i , h , {f}_{v} ) = {F}_{m} [ {Φ}_{m}^{( k )} ( {f}_{r} ( i ) , h , {f}_{θ} ( i ) ) ] \qquad ( 9 )$$

The symbol Fₘ[ ] represents a discrete Fourier transform operator for the cycle number m.

The first averaging unit 58B calculates an averaged signal by averaging frequency domain signals Ω^{(k)}(i, h, fᵥ) for the pulse number h and calculates the absolute value of the averaged signal or the square of the absolute value of the averaged signal as the Doppler spectrum Ω^{(k)}(i, fᵥ) related to the i-th target object. The Doppler spectrum Ω^{(k)}(i, fᵥ) may be normalized by its maximum value. Specifically, the first averaging unit 58B can calculate the Doppler spectrum Ω^{(k)}(i, fᵥ) from the frequency domain signal Ω^{(k)}(i, h, fᵥ) as expressed by the following Equation (10).

$${Ω}^{( k )} ( i , {f}_{v} ) = {\vert {\sum }_{h = 0}^{H - 1} {Ω}^{( k )} ( i , h , {f}_{v} ) \text{/} H \vert}^{2} \times {γ}_{3} \qquad ( 10 )$$

The symbol γ₃ represents a normalization factor.

Similarly to the second averaging unit 59A, the second averaging unit 59B calculates the average Doppler spectrum ω^{(k)}(fᵥ) from the Doppler spectrum Ω^{(k)}(i, fᵥ).

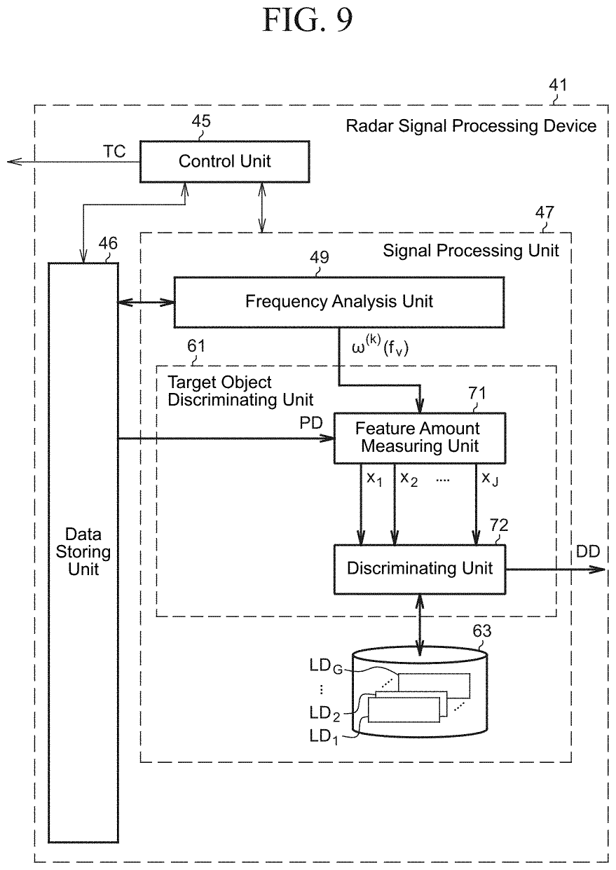

Next, configurations of the target object discriminating unit 61 and the learned data storing unit 63 in the signal processing unit 47 of the first embodiment will be described with reference to FIG. 9. FIG. 9 is a block diagram illustrating a schematic configuration of the target object discriminating unit 61 and the learned data storing unit 63 in the signal processing unit 47.

The target object discriminating unit 61 includes a feature amount measuring unit 71 and a discriminating unit 72. The feature amount measuring unit 71 acquires the average Doppler spectrum ω^{(k)}(fᵥ) and the peak information PD which are results of the frequency analysis by the frequency analysis unit 49. The feature amount measuring unit 71 calculates measurement values of feature amounts x₁, x₂, . . . , x_{J} that characterize the state of the target object moving in the observation space on the basis of the average Doppler spectrum ω^{(k)}(fᵥ) and the peak information PD. The subscript J represents an integer greater than or equal to 3. Note that, in the present embodiment, there are three or more types of feature amounts; however, it is not limited thereto. There may be a single or two or more types of feature amounts.

Now, for convenience of description, a combination of J feature amounts x₁, x₂, . . . , x_{J} is expressed as a feature amount vector x(k) as expressed in the following Equation (11).

$$x ( k ) = {[ {x}_{1} , {x}_{2} , … , {x}_{J} ]}^{T} \qquad ( 11 )$$

The superscript T is a symbol indicating transposition.

Let us denote the total number of recognition target classes by S and the S classes by C₁, C₂, . . . , and C_{S}. Using the learned data sets LD₁, . . . , and LD_{G} stored in the learned data storing unit 63, the discriminating unit 72 calculates posterior probabilities P(C₁|x(k)), . . . , and P(C_{S}|x(k)) that the target object belongs to the classes C₁, . . . , and C_{S}, respectively, from the measurement values of the feature amounts x₁, x₂, . . . , and x_{J} according to the Bayes' theorem. The symbol G represents a positive integer indicating the number of learned data sets. As will be described later, each of the learned data sets LD₁, . . . , and LD_{G} can be configured as a single parameter or several parameters that define the shape of a probability distribution P(xⱼ|Cₛ) or a lookup table. The discriminating unit 72 can discriminate the target object in the observation space on the basis of the posterior probabilities P(C₁|x(k)), . . . , and P(C_{S}|x(k)) that have been calculated and output data DD indicating the discrimination result.

According to the Bayes' theorem, the following Equations (12) and (13) hold.

$$\begin{matrix}P ( {C}_{s} \vert x ( k ) ) = \frac{P ( {C}_{s} ) \times P ( x ( k ) \vert {C}_{s} )}{P ( x ( k ) )} & ( 12 ) \\ {\sum }_{s = 1}^{S} P ( {C}_{s} \vert x ( k ) ) = 1 & ( 13 )\end{matrix}$$

In Equations (12) and (13), P(Cₛ|x(k)) represents a posterior probability distribution in which an object belongs to a class Cₛ when a feature amount vector x(k) is measured from the object, P(Cₛ) represents a prior probability distribution in which the class Cₛ is observed, P(x(k)|Cₛ) is a probability distribution in which the feature amount vector x(k) is measured when the object belonging to the class Cₛ is observed, and P(x(k)) is a prior probability distribution in which the feature amount vector x(k) is measured.

When a class Cₛ is given, it is assumed that the feature amounts x₁, x₂, . . . , and x_{J} are independent from each other. At this point, Equation (12) is expressed by the following Equation (14).

$$\begin{matrix}P ( {C}_{s} \vert x ( k ) ) = \frac{P ( {C}_{s} ) \times P ( {x}_{1} \vert {C}_{s} ) \times P ( {x}_{2} \vert {C}_{s} ) ⋯ \times P ( {x}_{J} \vert {C}_{s} )}{P ( x ( k ) )} \\ = \frac{P ( {C}_{s} ) \times {\prod }_{j = 1}^{J} P ( {x}_{j} \vert {C}_{s} )}{P ( x ( k ) )}\end{matrix} \qquad ( 14 )$$

In Equation (14), P(xⱼ|Cₛ) is a probability distribution in which a feature amount xⱼ is measured when the object belonging to the class Cₛ is observed. The learned data set defining the probability distribution P (xⱼ|Cₛ) is stored in the learned data storing unit 63. The discriminating unit 72 can calculate posterior probabilities P (C₁|x(k)), . . . , and P(C_{S}|x(k)) according to Equation (14), and can set a class having a high posterior probability as a discrimination result.

Each of the probability distributions P(xⱼ|Cₛ) can be expressed by a parametric model or a nonparametric model. A parametric model is a statistical model including a single or several parameters. For example, a Poisson distribution, a normal distribution (Gaussian distribution), a chi-square (χ²) distribution, or a normal mixture distribution (Gaussian mixture distribution) can be applied as the parametric model. The normal mixture distribution is a distribution expressed by a linear combination (linear superposition) of a plurality of normal distributions. A parameter of the probability distribution P(xⱼ|Cₛ) expressed by the parametric model can be estimated from a histogram distribution (normalized histogram) having been measured in advance for an object belonging to each class by an algorithm such as the maximum likelihood method. In a case where a parametric model is used, the learned data set LD_{g} is only required to have parameters that define the probability distribution P(xⱼ|Cₛ), and thus there is an advantage that the memory efficiency is high.

In a case where the probability distribution P(xⱼ|Cₛ) is expressed by a nonparametric model, it is possible to use a histogram distribution (normalized histogram) measured in advance for an object belonging to each class or a histogram obtained by smoothing the histogram distribution. In this case, a lookup table value that defines the shape of the probability distribution P(xⱼ|Cₛ) can be used as the learned data set LD_{g}.

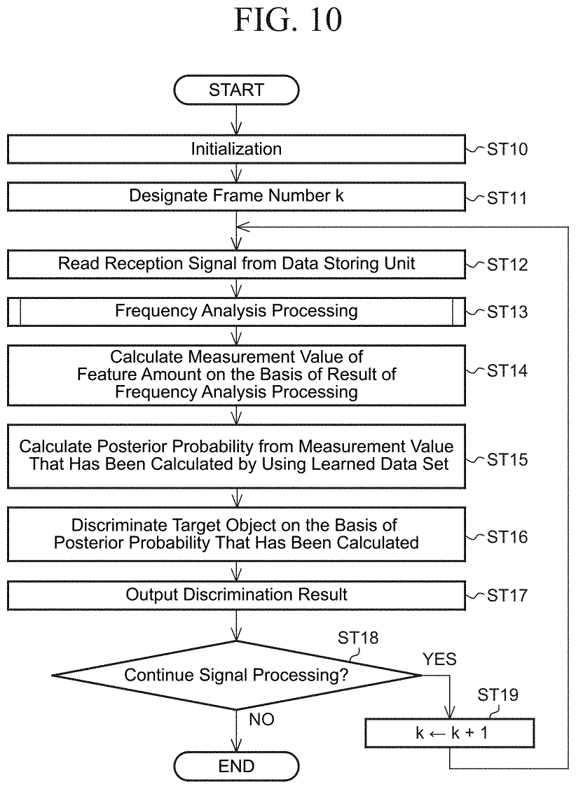

Next, the operation of the signal processing unit 47 will be described with reference to FIG. 10. FIG. 10 is a flowchart schematically illustrating a procedure of signal processing by the signal processing unit 47.

Referring to FIG. 10, first, the control unit 45 sets various parameters to initial values (step ST10). At this point, prior probabilities P(C₁) to P(Cₛ) of Equation (14) are set to an initial value (for example, 1/S).

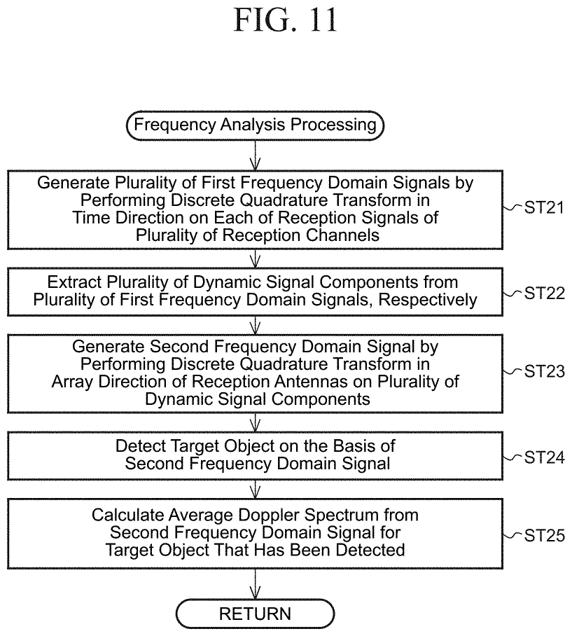

Next, the control unit 45 designates a frame number k (step ST11). The domain conversion unit 50 reads the reception signal zₘ^{(k)}(n, h, q) for the frame number k from the data storing unit 46 (step ST12) and performs the frequency analysis process thereon (step ST13). FIG. 11 is a flowchart schematically illustrating a procedure of frequency analysis processing.

Referring to FIG. 11, as described above, the quadrature transform unit 51 performs a discrete quadrature transform in the time direction on the reception signals zₘ^{(k)}(n, h, 0) to zₘ^{(k)}(n, h, Q−1) of the Q reception channels, thereby generating first frequency domain signals Γₘ^{(k)}(fᵣ, h, 0) to Γₘ^{(k)} (fᵣ, h, Q−1) each corresponding to one of the Q reception channels (step ST21).

Next, as described above, the signal component extracting unit 52 extracts dynamic signal components Δₘ^{(k)}(fᵣ, h, 0) to Δₘ^{(k)}(fᵣ, h, Q−1) from the first frequency domain signals Γₘ^{(k)}(fᵣ, h, 0) to Γₘ^{(k)}(fᵣ, h, Q−1), respectively, by removing each signal component corresponding to a stationary object from the first frequency domain signals Γₘ^{(k)}(fᵣ, h, 0) to Γₘ^{(k)}(fᵣ, h, Q−1) (step ST22).

Next, as described above, the quadrature transform unit 53 calculates a second frequency domain signal Φₘ^{(k)}(fᵣ, h, f_{θ}) by performing a discrete quadrature transform in the array direction of the reception antennas 30₀ to 30_{Q-1} on the dynamic signal components Δₘ^{(k)}(fᵣ, h, 0) to Δₘ^{(k)}(fᵣ, h, Q−1) (step ST23).

Next, the target object detecting unit 54 detects the target object moving in the observation space from the second frequency domain signal Φₘ^{(k)}(fᵣ, h, f_{θ}) (step ST24). Specifically, as described above, the target object detecting unit 54 detects a set of frequency numbers (fᵣ(i), f_{θ}(i)) corresponding to the position coordinate values (relative distance and azimuth angle) of the target object moving in the observation space from the second frequency domain signal Φₘ^{(k)}(fᵣ, h, f_{θ}).

Next, the Doppler spectrum calculating unit 57 reads a second frequency domain signal Φₘ^{(k)}(fᵣ(i), h, f_{θ}(i)) for the detected target object from the data storing unit 46 and calculates the average Doppler spectrum ω^{(k)}(fᵥ) from the second frequency domain signal Φₘ^{(k)}(fᵣ(i), h, f_{θ}(i)) (step ST25).

Next, referring to FIG. 10, the feature amount measuring unit 71 calculates measurement values of the feature amounts x₁, x₂, . . . , x_{J} on the basis of the average Doppler spectrum ω^{(k)} (fᵥ) and the peak information PD obtained by the frequency analysis processing (step ST14).

For example, the feature amount measuring unit 71 can calculate the number of target objects Np(k) detected by the target object detecting unit 54 in step ST24 of FIG. 11 as a first feature amount x₁. In this case, since the histogram distribution of the first feature amount x₁(=Np(k)) can be approximated by a Poisson distribution as expressed in the following Equation (15), the probability distribution P(x₁|Cₛ) can be expressed using a Poisson distribution.

$${f}_{a} ( {x}_{j} ) = \frac{{λ}^{{x}_{j}}}{{x}_{j} !} \cdot exp ( - λ ) \qquad ( 15 )$$

The parameter λ is a positive value.

Furthermore, the feature amount measuring unit 71 can calculate a value for evaluating a difference between the number of maximum peaks Nd(k) appearing in a predetermined low frequency domain in the average Doppler spectrum ω^{(k)}(fᵥ) and the number of maximum peaks Nu(k) appearing in a predetermined high frequency domain in the average Doppler spectrum ω^{(k)}(fᵥ) as a second feature amount x₂. Specifically, it is only required to calculate the second feature amount x₂ as expressed by the following Equation (16).

$${x}_{2} = 10 \cdot {log}_{10} ( \frac{Nu ( k ) + 1}{Nd ( k ) + 1} ) \qquad ( 16 )$$

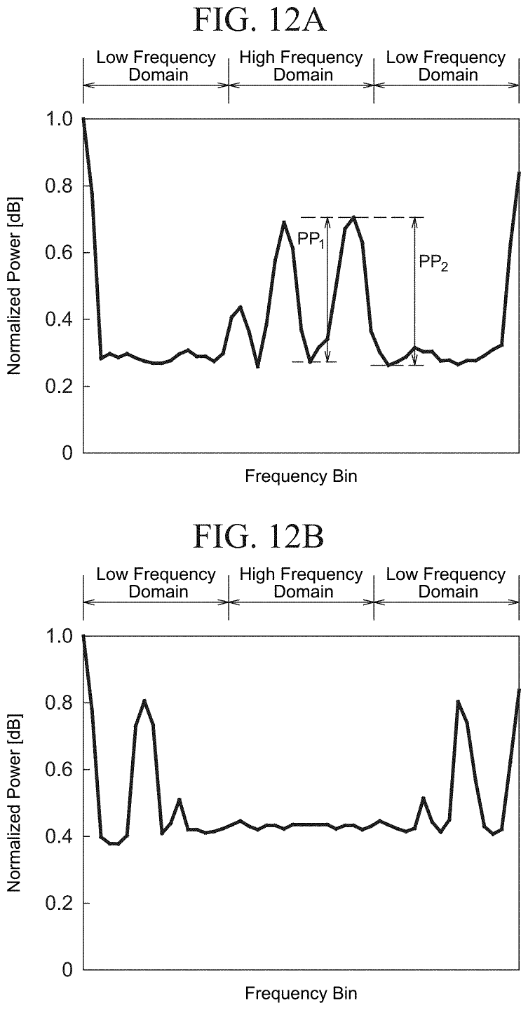

FIGS. 12A and 12B are graphs conceptually illustrating the average Doppler spectrum ω^{(k)}(fᵥ). In these graphs, the horizontal axis represents the frequency bin (frequency number) fᵥ, and the vertical axis represents the normalized power (unit: dB). Note that the frequency bins are rearranged in order to divide the high frequency domain and the low frequency domain. In the graph of FIG. 12A, two maximum peaks in the high frequency domain are detected, and no maximum peak is detected in the low frequency domain. Meanwhile, in the graph of FIG. 12B, no maximum peak is detected in the high frequency domain, and two maximum peaks in the low frequency domain are detected.

Since the histogram distribution of the second feature amount x₂ of Equation (16) can be approximated by a normal distribution (Gaussian distribution) as expressed by the following Equation (17), a probability distribution P(x₂|Cₛ) can be expressed using a normal distribution.

$${f}_{b} ( {x}_{j} ) = \frac{1}{\sqrt{2 π} σ} \cdot exp ( - \frac{{( {x}_{j} - μ )}^{2}}{2 {σ}^{2}} ) \qquad ( 17 )$$

The parameter μ is an average, and the parameter σ² is variance.

Furthermore, by detecting maximum peak(s) each having a signal-to-noise ratio that is greater than or equal to a predetermined value from the maximum peaks appearing in the average Doppler spectrum ω^{(k)}(fᵥ), the feature amount measuring unit 71 can calculate the number of maximum peaks Ns(k) that has been detected as a third feature amount x₃. For example, the feature amount measuring unit 71 can determine that a maximum peak has a signal-to-noise ratio which is greater than or equal to a predetermined value if, as illustrated in FIG. 12A, focusing on a height PPₘᵢₙ which is the smaller one of a height PP₁, with respect to the maximum peak appearing in the average Doppler spectrum ω^{(k)}(fᵥ), from a valley appearing on the left side to the maximum peak and a height PP₂ from a valley appearing on the right side, with respect to the maximum peak, to the maximum peak, the height PPₘᵢₙ exceeds a threshold value.

Since the histogram distribution of the third feature amount x₃(=Ns(k)) can be approximated by a Poisson distribution as expressed in Equation (15), a probability distribution P(x₃|Cₛ) can be expressed using a Poisson distribution.

Furthermore, the feature amount measuring unit 71 can calculate a temporal change amount between the current average Doppler spectrum ω^{(k)}(fᵥ) calculated for the frame number k and an average Doppler spectrum ω^{k-1}(fᵥ) that has been previously calculated for the frame number k−1 as a fourth feature amount x₄. Specifically, it is only required to calculate the fourth feature amount x₄ as expressed by the following Equation (18).

$${x}_{4} = {\sum }_{{f}_{v}} \vert {ω}^{( k )} ( {f}_{v} ) - {ω}^{( k - 1 )} ( {f}_{v} ) \vert \qquad ( 18 )$$

In this case, since the histogram distribution of the fourth feature amount x₄ can be approximated by a chi-square (χ²) distribution as expressed in the following Equation (19), the probability distribution P(x₄|Cₛ) can be expressed using a chi-square distribution.

$${f}_{c} ( {x}_{j} ) = \frac{1}{{2}^{\frac{n}{2}} \cdot Γ ( \frac{n}{2} )} \cdot {x}_{j}^{\frac{n}{2} - 1} \cdot exp ( - \frac{{x}_{j}}{2} ) \qquad ( 19 )$$

The parameter n represents the degree of freedom, and Γ( ) represents a gamma function.

After step ST14, using the learned data sets LD₁, . . . , and LD_{G} stored in the learned data storing unit 63, the discriminating unit 72 calculates posterior probabilities P(C₁|x(k)), . . . , and P(Cₛ|x(k)) that the target object belongs to the classes C₁, . . . , and C_{S}, respectively, from the measurement values of the feature amounts x₁, x₂, . . . , and x_{J} according to the Bayes' theorem (step ST15). At this time, the discriminating unit 72 first calculates the numerator of the right side of Equation (14) by the following Equation (20).

$$ϕ ( {C}_{s} \vert x ( k ) ) = P ( {C}_{s} ) \times {\prod }_{j = 1}^{J} P ( {x}_{j} \vert {C}_{s} ) \qquad ( 20 )$$

Here, in a first time, the discriminating unit 72 is only required to calculate the numerator φ(Cₛ|x(k)) by setting all the prior probabilities P(Cₛ) to an initial value (for example, 1/S). In the case of a second and subsequent times, the discriminating unit 72 is only required to calculate the numerator φ(Cₛ|x(k)) using the posterior probability P(Cₛ|x(k−1)) that has been previously calculated for a frame number k−1 as the prior probability P(Cₛ). The discriminating unit 72 can calculate a posterior probability P(Cₛ|x(k)) from the following Equation (21).

$$P ( {C}_{s} \vert x ( k ) ) = \frac{ϕ ( {C}_{s} \vert x ( k ) )}{{\sum }_{s = 1}^{S} ϕ ( {C}_{s} \vert x ( k ) )} \qquad ( 21 )$$

After step ST15, the discriminating unit 72 discriminates the target object in the observation space on the basis of the posterior probabilities P(C₁|x(k)), . . . , and P(Cₛ|x(k)) (step ST16) and outputs the data DD indicating the discrimination result (step ST17). For example, the discriminating unit 72 can set a class corresponding to the highest posterior probability among the posterior probabilities P(C₁|x(k)), . . . , and P(Cₛ|x(k)) as the discrimination result.

Next, in a case where it is determined not to continue the signal processing (NO in step ST18), the control unit 45 ends the signal processing. In a case where it is determined to continue the signal processing (YES in step ST18), the control unit 45 increments the frame number k (step ST19) and shifts the procedure to step ST12.

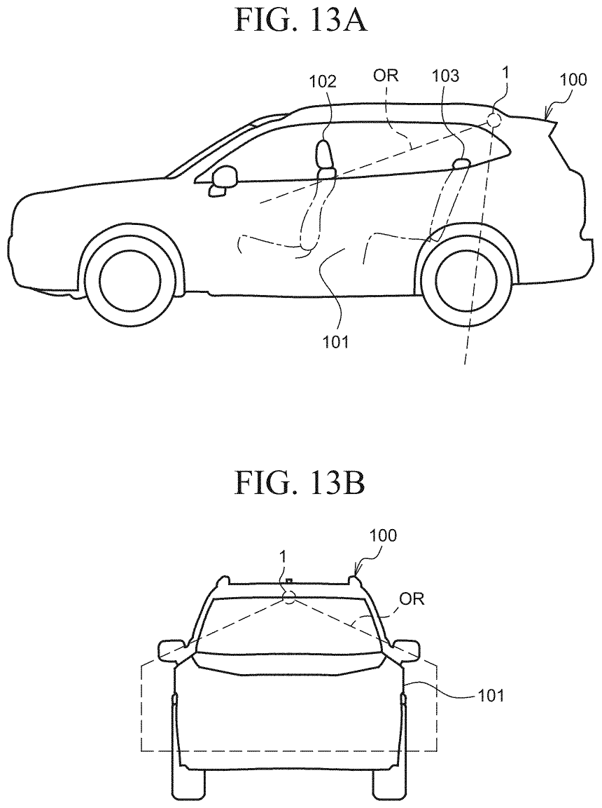

The radar sensor system 1 described above can be mounted on, for example, a vehicle such as a passenger car. FIGS. 13A and 13B are diagrams illustrating the radar sensor system 1 installed in a compartment of a vehicle 100. As illustrated in FIG. 13A, an observation space OR of the radar sensor system 1 includes front seats 102, rear seats 103, and both side faces inside the vehicle body 101.

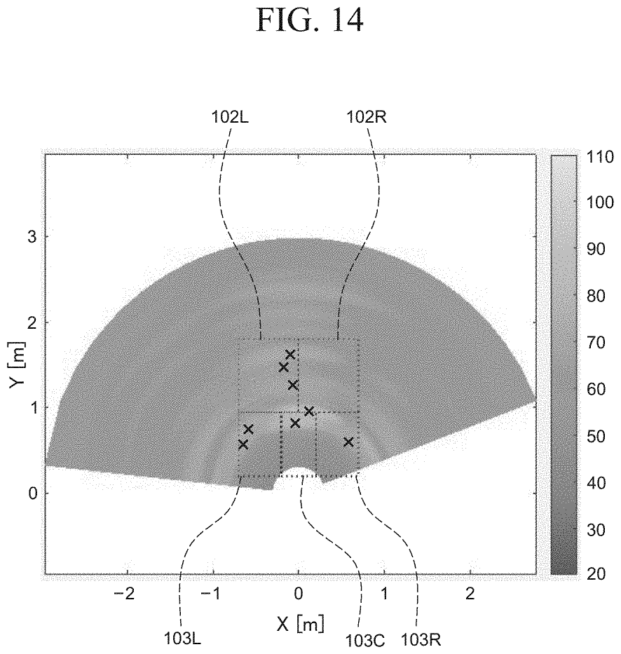

FIG. 14 is a graph illustrating a two-dimensional spectrum M^{(k)}(fᵣ, f_{θ}) that has been actually calculated. In this graph, the horizontal axis represents an X axis (unit: meter) of a rectangular coordinate system, and the horizontal axis represents a Y axis (unit: meter) orthogonal to the X axis. In addition, the value of the two-dimensional spectrum M^{(k)}(fᵣ, f_{θ}) increases as the display density decreases (brighter), and the value of the two-dimensional spectrum M^{(k)}(fᵣ, f_{θ}) decreases as the display density increases (darker). A front left seat 102L, a front right seat 102R, a rear left seat 103L, a rear center seat 103C, and a rear right seat 103R are indicated by dotted lines. A mark “x” in FIG. 14 represents position coordinate values of a target object that has been detected.

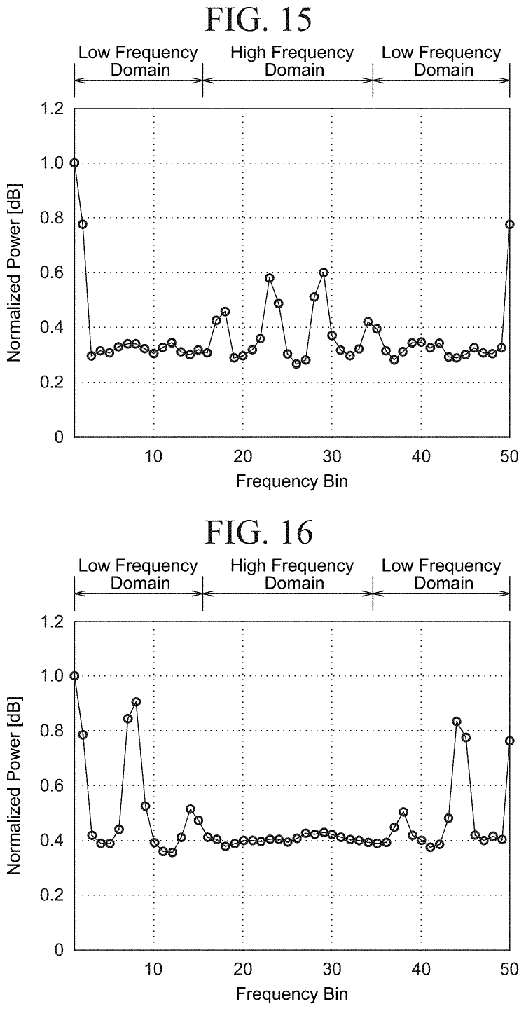

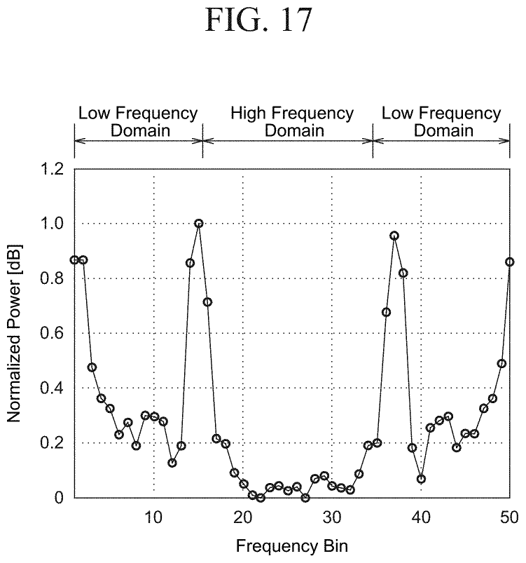

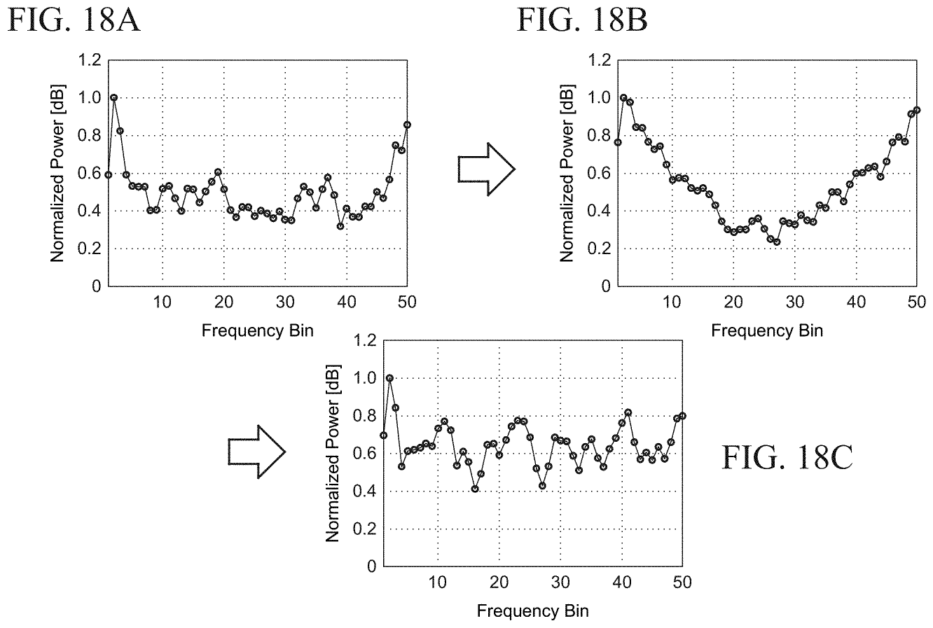

FIGS. 15 to 17 are graphs each illustrating an average Doppler spectrum ω^{(k)}(fᵥ) that has been actually calculated. In these graphs, the horizontal axis represents the frequency bin (frequency number) fᵥ, and the vertical axis represents the normalized power (unit: dB). Note that the frequency bins are rearranged in order to divide the high frequency domain and the low frequency domain. In the graph of FIG. 15, two maximum peaks corresponding to a vibrating state of a smartphone appear in the high frequency domain. In the graph of FIG. 16, a plurality of maximum peaks corresponding to the motion of a doll imitating a sleeping infant appear in the low frequency domain. In the graph of FIG. 17, two maximum peaks corresponding to the shaking state of the vehicle body appear in the low frequency domain.

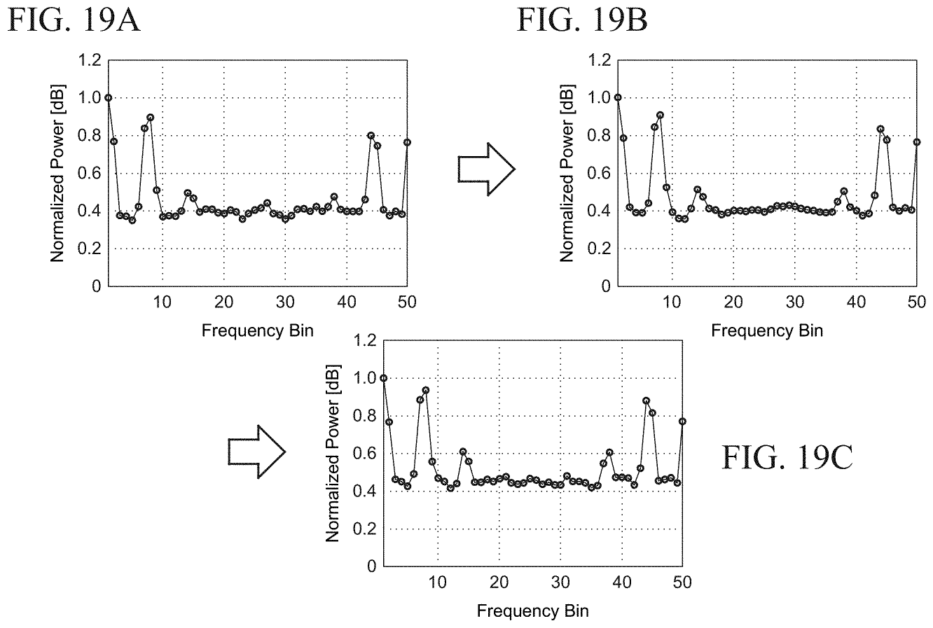

FIGS. 18A, 18B, and 18C are graphs illustrating average Doppler spectra ω^{(k-2)} (fᵥ), ω^{(k-1)}(fᵥ), and ω^{(k)}(fᵥ), respectively, which have been actually calculated when the awake state of an infant is observed. FIGS. 19A, 19B, and 19C are graphs illustrating average Doppler spectra ω^{(k-2)}(fᵥ), ω^{(k-1)}(fᵥ), and ω^{(k)}(fᵥ) which have been actually calculated when the motion of a doll imitating a sleeping infant is observed. In the graphs of FIGS. 18A to 18C and FIGS. 19A to 19C, the horizontal axis represents the frequency bin (frequency number) fᵥ, and the vertical axis represents the normalized power (unit: dB).

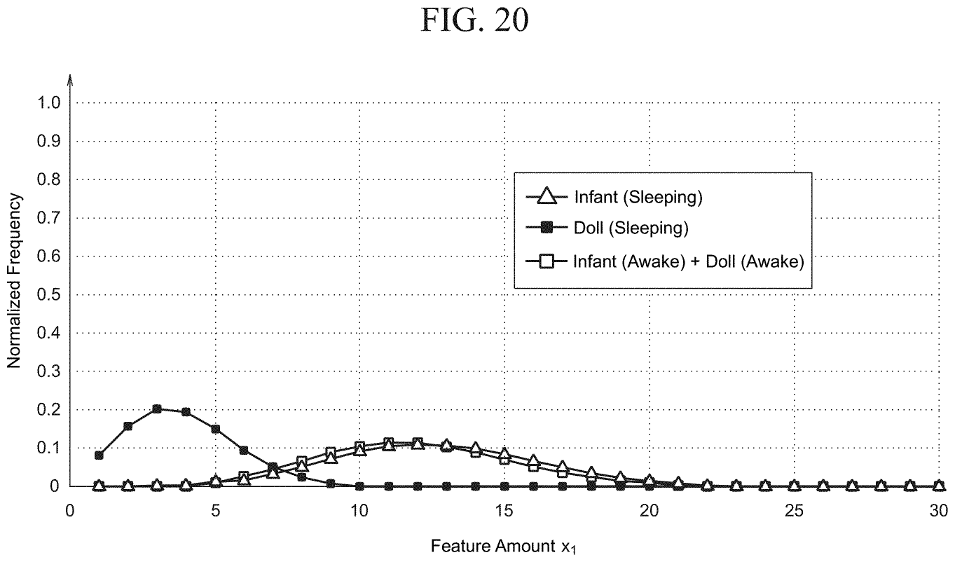

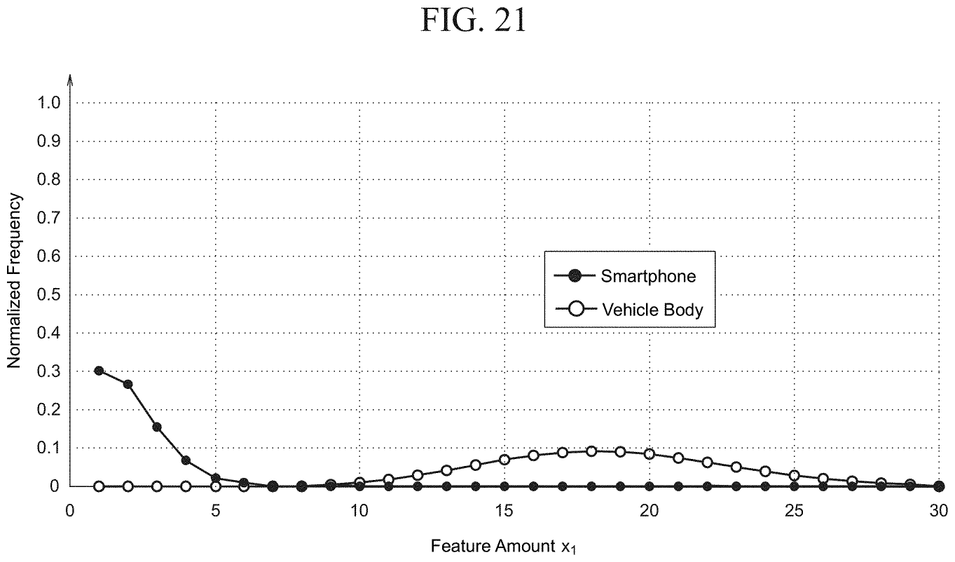

FIGS. 20 and 21 are graphs illustrating histogram distributions of the first feature amount x₁(=Np(k)) measured in a case where five states of a smartphone, a shaking vehicle body (“vehicle body”), a sleeping infant (“infant (sleeping)”), a doll imitating a sleeping infant (“doll (sleeping)”), and a combination of an infant in an awake state and a doll in an awake state (“infant (awake)+doll (awake)”) are separately observed. In the graphs of FIGS. 20 and 21, the horizontal axis represents the first feature amount x₁, and the vertical axis represents the normalized frequency. It can be seen that each of the histogram distributions in FIGS. 20 and 21 can be approximated by a Poisson distribution.

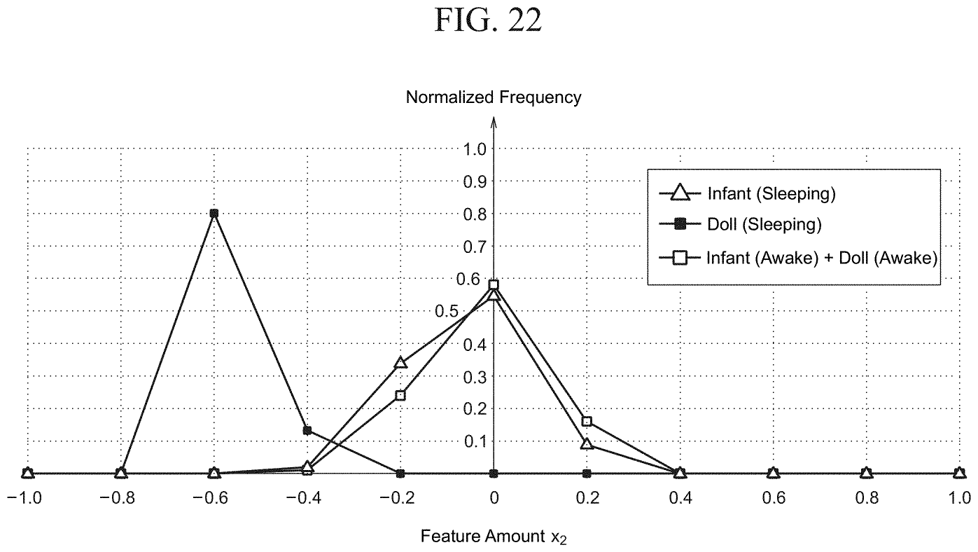

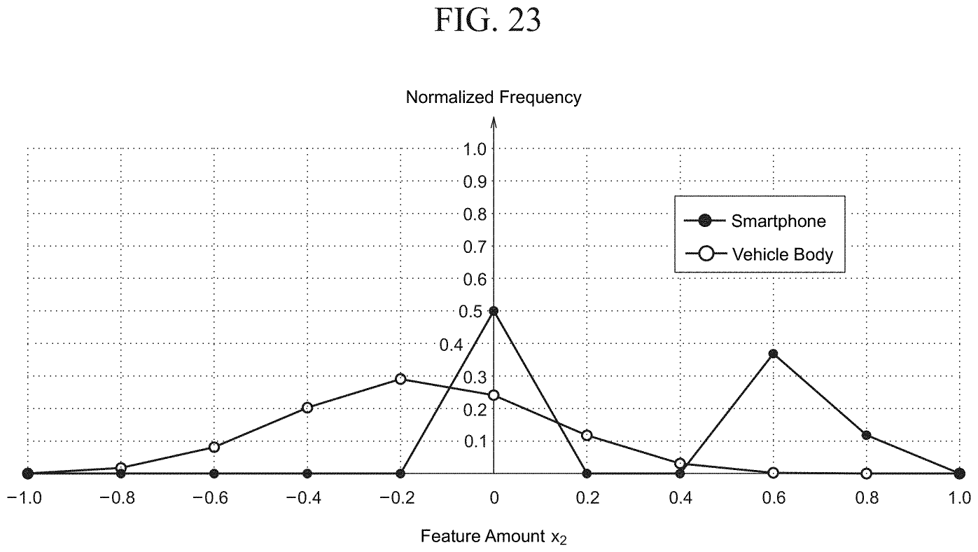

FIGS. 22 and 23 are graphs illustrating histogram distributions of the second feature amount x₂ (Equation (16)) measured in a case where the five states are separately observed similarly to the cases of FIGS. 20 and 21. In the graphs of FIGS. 22 and 23, the horizontal axis represents the second feature amount x₂, and the vertical axis represents the normalized frequency. It can be seen that each of the histogram distributions in FIGS. 22 and 23 can be approximated by a normal mixture distribution (Gaussian mixture distribution).

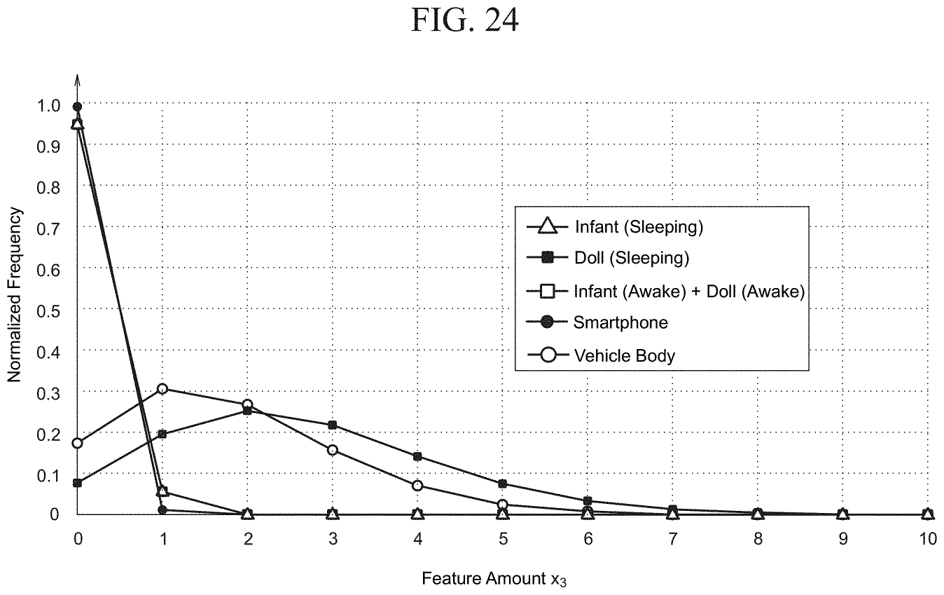

FIG. 24 is a graph illustrating histogram distributions of the third feature amount x₃(=Ns(k)) measured in a case where the five states are separately observed similarly to the cases of FIGS. 20 and 21. In the graph of FIG. 24, the horizontal axis represents the third feature amount x₃, and the vertical axis represents the normalized frequency. It can be seen that each of the histogram distributions in FIG. 24 can be approximated by a Poisson distribution.

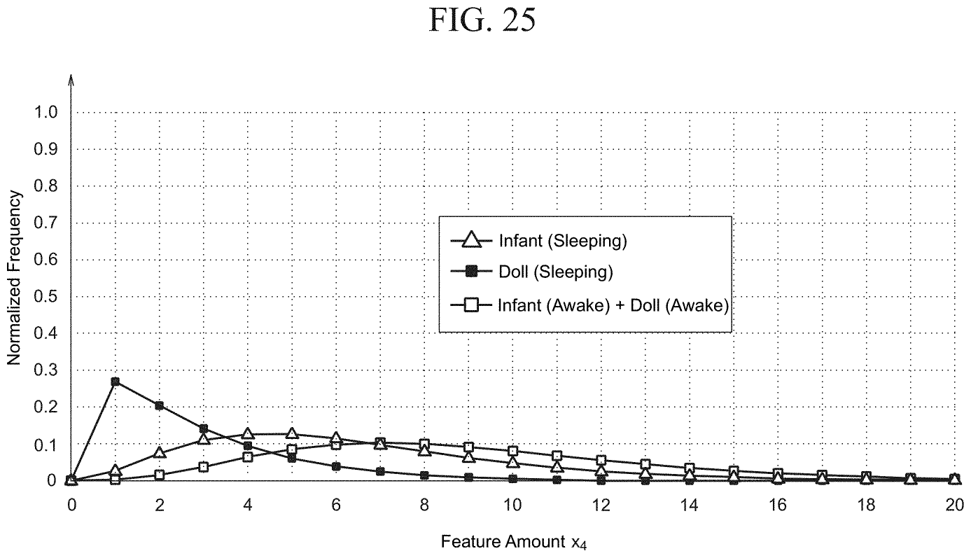

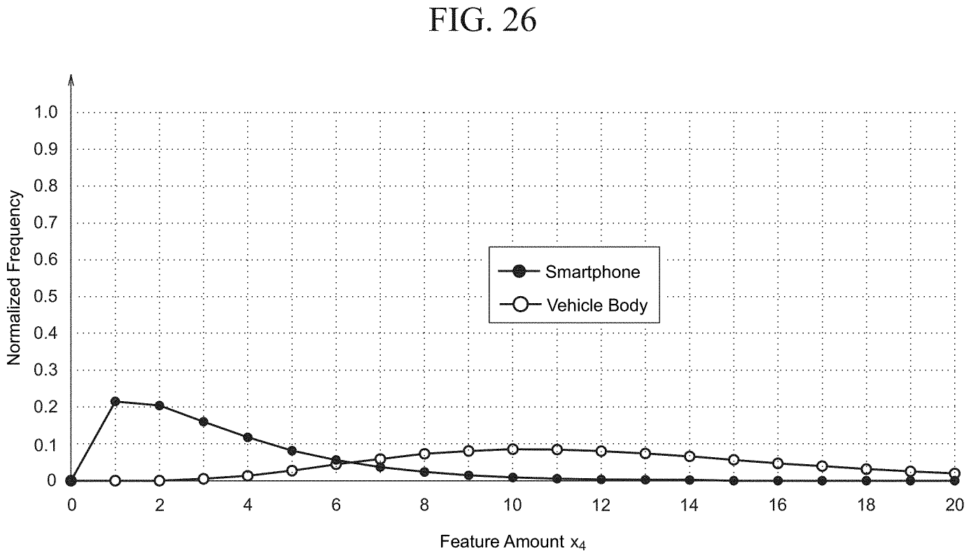

FIGS. 25 and 26 are graphs illustrating histogram distributions of the fourth feature amount x₄ (Equation (18)) measured in a case where the five states are separately observed similarly to the cases of FIGS. 20 and 21. In the graphs of FIGS. 25 and 26, the horizontal axis represents the fourth feature amount x₄, and the vertical axis represents the normalized frequency. It can be seen that each of the histogram distributions in FIGS. 25 and 26 can be approximated by a chi-square (χ²) distribution.

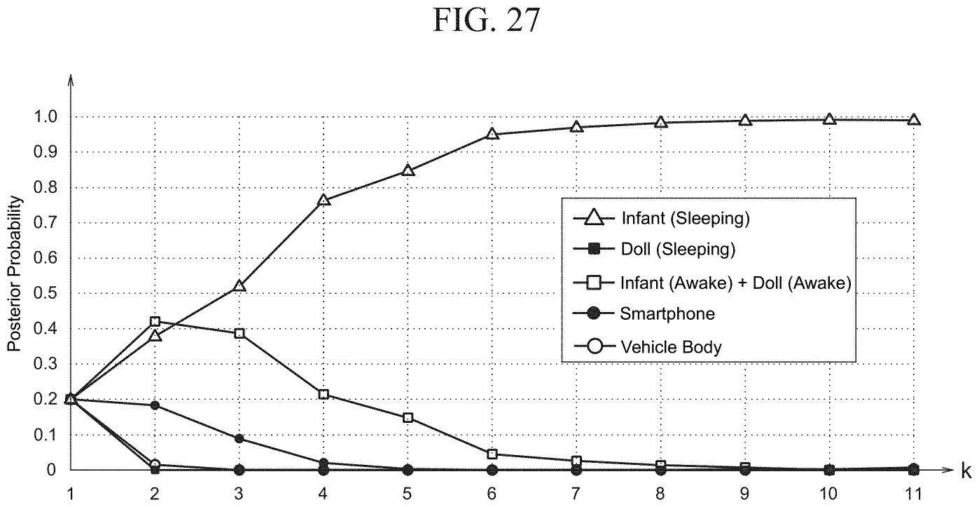

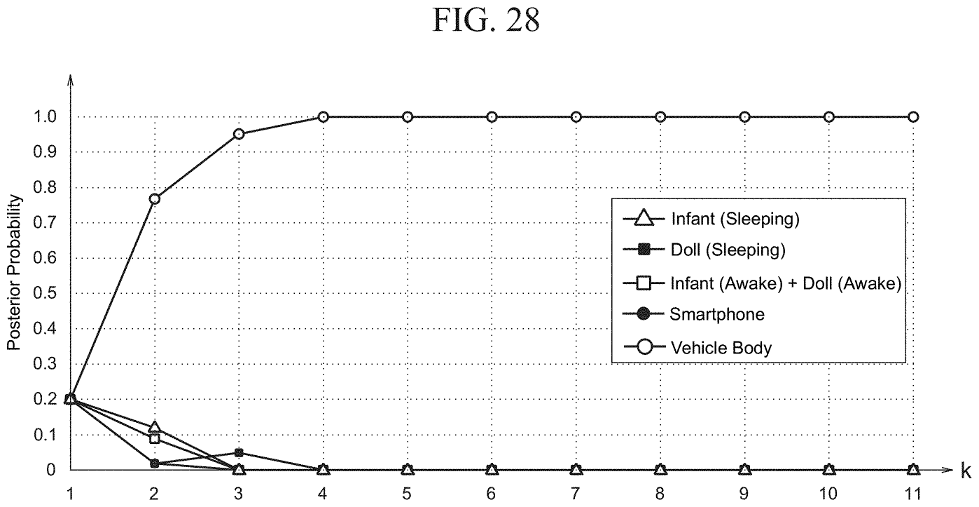

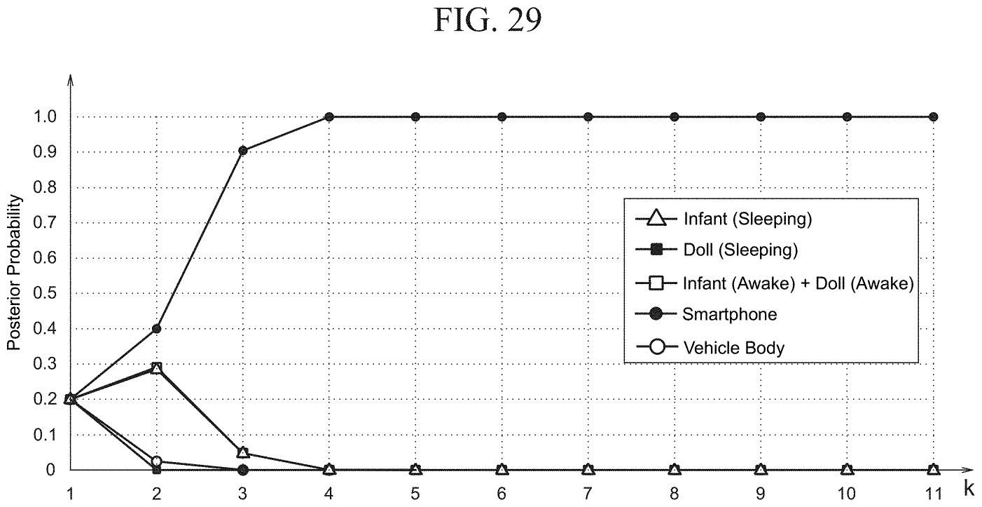

FIG. 27 is a graph illustrating the time transition of the posterior probability calculated in a case where only a sleeping infant is observed in the vehicle 100. In this graph, the horizontal axis represents the frame number k, and the vertical axis represents the posterior probability. In the graph of FIG. 27, the manner how the posterior probability converges to a correct value with the lapse of time is illustrated. Similarly, FIG. 28 is a graph illustrating the time transition of the posterior probability calculated in a case where only the shake of the vehicle body 101 is observed in the vehicle 100. Also in the graph of FIG. 28, the manner how the posterior probability converges to a correct value with the lapse of time is illustrated. Similarly, FIG. 29 is a graph illustrating the time transition of the posterior probability calculated in a case where only a smartphone vibrating in the vehicle 100 is observed. Also in the graph of FIG. 29, the manner how the posterior probability converges to a correct value with the lapse of time is illustrated.

As described above, in the first embodiment, the feature amount measuring unit 71 calculates measurement values of one or a plurality of types of feature amounts x₁ to x_{J} that characterize the state of the target object moving in the observation space on the basis of the frequency analysis result by the frequency analysis unit 49. Using the learned data sets LD₁ to LD_{G} stored in the learned data storing unit 63, the discriminating unit 72 can calculate a posterior probability that the target object belongs to a single or each of a plurality of classes from the measurement values of the feature amounts x₁ to x_{J} according to the Bayes' theorem and can discriminate the target object in the observation space on the basis of the posterior probability that has been calculated. Therefore, the target object can be discriminated with high accuracy.

Although the embodiment according to the present invention and modifications thereof have been described above with reference to the drawings, the embodiment and the modifications are examples of the present invention, and there may be various embodiments other than the embodiment and the modifications. Note that it is possible to modify any component of the first embodiment or to omit any component of the first embodiment within the scope of the present invention.

Note that the sensor unit 10 of the present embodiment operates in the FMCW scheme; however, it is not limited thereto. For example, the configuration of the sensor unit 10 may be modified so as to operate in a pulse compression system.

### INDUSTRIAL APPLICABILITY

Since a radar signal processing device, a radar sensor system, and a signal processing method according to the present invention enable estimation of the type of a target object moving in an observation space with high accuracy, the radar signal processing device, the radar sensor system, and the signal processing method can be used for, for example, a sensor system that detects a target object (for example, a living body such as an infant or a small animal) inside a vehicle such as a passenger car or a railway vehicle.

### REFERENCE SIGNS LIST

1: radar sensor system, 10: sensor unit, 20: transmission antenna, 21: transmission circuit, 22: voltage generator, 23: voltage-controlled oscillator, 24: distributor, 25: amplifier, 30₀ to 30_{Q-1}: reception antenna, 31₀ to 31_{Q-1}: receiver, 32₀ to 32_{Q-1}: low noise amplifier, 33₀ to 33_{Q-1}: mixer, 34₀ to 34_{Q-1}: IF amplifier, 35₀ to 35_{Q-1}: filter, 36₀ to 36_{Q-1}: A/D converter (ADC), 41: radar signal processing device, 45: control unit, 46: data storing unit, 47: signal processing unit, 49: frequency analysis unit, 50: domain conversion unit, 51: quadrature transform unit, 52: signal component extracting unit, 52A: time averaging unit, 52B: subtractor, 53: quadrature transform unit, 54: target object detecting unit, 55: time averaging unit, 56: peak detection unit, 57: Doppler spectrum calculating unit, 57A, 57B: quadrature transform unit, 58A, 58B: first averaging unit, 59A, 59B: second averaging unit, 61: target object discriminating unit, 63: learned data storing unit, 71: feature amount measuring unit, 72: discriminating unit, 90: signal processing circuit, 91: processor, 92: memory, 93: storage device, 94: input and output interface unit, 95: signal path, 100: vehicle, 101: vehicle body, 102: front seat, 103: rear seat

1. A radar signal processing device that operates in cooperation with a sensor unit comprising a single or a plurality of reception antennas to receive a reflection wave generated by reflection of a transmission radio wave in a frequency band lower than a frequency in an optical frequency domain in an observation space and a reception circuit to generate a reception signal of each of a single or a plurality of reception channels by performing signal processing on an output signal of each of the single or the plurality of reception antennas, the radar signal processing device comprising processing circuitry
to perform frequency analysis on the reception signal,
to perform calculation of a measurement value of each of a single or a plurality of types of feature amounts, each of the single or the plurality of feature amounts characterizing a state of each of a single or a plurality of target objects moving in the observation space on a basis of a result of the frequency analysis,
to store a single or a plurality of learned data sets that define a probability distribution in which the single or the plurality of types of feature amounts are each measured when an object belonging to a single or a plurality of classes is observed in the observation space,
to perform calculation of a posterior probability that each of the single or the plurality of target objects belongs to each of the single or the plurality of classes from the measurement value by Bayes' theorem using the learned data set and to discriminate each of the single or the plurality of target objects on a basis of the posterior probability that has been calculated,
to perform conversion of the reception signal into a frequency domain signal in a frequency domain corresponding to spatial coordinates of the observation space, and
to detect each of the single or the plurality of target objects from the frequency domain signal.

2. The radar signal processing device according to claim 1,
wherein the frequency analysis, the calculation of the measurement value, and the calculation of the posterior probability are iteratively performed, and
the calculation of the posterior probability is performed by using the posterior probability that has previously been calculated as a prior probability.

3. The radar signal processing device according to claim 1, wherein the number of the single or the plurality of target objects is calculated as one of the single or the plurality of types of feature amounts.

4. The radar signal processing device according to claim 1,
wherein the plurality of reception antennas is spatially arranged to form an array, and
the processing circuitry performs, in the conversion of the reception signal,
to generate a plurality of first frequency domain signals each corresponding to one of the plurality of reception channels by performing a discrete quadrature transform in a time direction on each of reception signals of the plurality of reception channels;
to extract each of a plurality of dynamic signal components from one of the plurality of first frequency domain signals by removing a signal component corresponding to a stationary object from each of the plurality of first frequency domain signals; and
to generate a second frequency domain signal as the frequency domain signal by performing a discrete quadrature transform on the plurality of dynamic signal components in a direction of the array of the reception antennas.

5. The radar signal processing device according to claim 1,
wherein the processing circuitry further performs to generate a third frequency domain signal corresponding to each of the single or the plurality of target objects by performing a discrete quadrature transform on the frequency domain signal for the single or the plurality of target objects detected and to calculate an average Doppler spectrum from the third frequency domain signal.

6. The radar signal processing device according to claim 5, wherein the processing circuitry calculates a value for evaluating a difference between the number of maximum peaks appearing in a predetermined low frequency domain in the average Doppler spectrum and the number of maximum peaks appearing in a predetermined high frequency domain in the average Doppler spectrum as one of the single or the plurality of types of feature amounts.

7. The radar signal processing device according to claim 5, wherein the processing circuitry detects at least one maximum peak at which a signal-to-noise ratio is greater than or equal to a predetermined value from among a single or a plurality of maximum peaks appearing in the average Doppler spectrum and calculates the number of the at least one maximum peak that has been detected as one of the single or the plurality of types of feature amounts.

8. The radar signal processing device according to claim 5, wherein the processing circuitry calculates a temporal change amount between the average Doppler spectrum which is newly calculated and the average Doppler spectrum that has been previously calculated as one of the single or the plurality of types of feature amounts.

9. The radar signal processing device according to claim 1, wherein the single or the plurality of learned data sets are configured as a lookup table.

10. A radar sensor system comprising:
the radar signal processing device according to claim 1; and
the sensor unit.

11. A signal processing method executed by a radar signal processing device that operates in cooperation with a sensor unit comprising a single or a plurality of reception antennas to receive a reflection wave generated by reflection of a transmission radio wave in a frequency band lower than a frequency in an optical frequency domain in an observation space and a reception circuit to generate a reception signal of each of a single or a plurality of reception channels by performing signal processing on an output signal of each of the single or the plurality of reception antennas, the signal processing method comprising:
performing frequency analysis on the reception signal;
calculating a measurement value of each of a single or a plurality of types of feature amounts, each of the single or the plurality of feature amounts characterizing a state of each of a single or a plurality of target objects moving in the observation space on a basis of a result of the frequency analysis;
referring to a single or a plurality of learned data sets that define a probability distribution in which the single or the plurality of types of feature amounts are each measured when an object belonging to a single or a plurality of classes is observed in the observation space and calculating a posterior probability that each of the single or the plurality of target objects belongs to each of the single or the plurality of classes from the measurement value by Bayes' theorem using the learned data set;
discriminating each of the single or the plurality of target objects on a basis of the posterior probability that has been calculated;
performing conversion of the reception signal into a frequency domain signal in a frequency domain corresponding to spatial coordinates of the observation space; and
detecting each of the single or the plurality of target objects from the frequency domain signal.
